(19) United States
(12) Patent Application Publication
(10) Pub. No.: US 2009/0187735 A1
(43) Pub. Date: Jul. 23, 2009

(54) MICROCONTROLLER HAVING DUAL-CORE ARCHITECTURE

(75) Inventors: Chien-Liang Lin, Hsinchu City (TW); Wen-Hsiang Huang, Hsinchu City (TW); Hao-Jan Chen, Taipei City (TW)

Correspondence Address: Muncy, Geissler, Olds & Lowe, PLLC, P.O. BOX 1364, FAIRFAX, VA, 22038-1364, US

(73) Assignee: SONIX Technology Co., Ltd.

(21) Appl. No.: 12/357,779

(22) Filed: Jan. 22, 2009

(30) Foreign Application Priority Data
Jan. 22, 2008 (TW) 097102279

(51) Int. Cl. G06F 15/76; G06F 9/02

(52) U.S. Cl. 712/30; 712/E09.002

(57) ABSTRACT

A microcontroller having dual-core architecture is provided. Using a unique hardware configuration of memories, control registers and reset machines, the invention not only reduces hardware cost, but also improves management efficiency and system stability.

This application claims priority of application No. 097102279 filed in Taiwan R.O.C on Jan. 22, 2008, the entire contents of which are hereby incorporated by reference.

### BACKGROUND OF THE INVENTION

1. Field of the invention

The invention relates to a microcontroller, particularly to a microcontroller having dual-core architecture provided with memories, registers, and reset machines.

2. Description of the Related Art

Although an 8-bit microcontroller usually utilizes single-core architecture, it can be found in most of applications that a single-core microcontroller is not easy to achieve the target of firmware real-time control. However, in an emergency, firmware real-time control is a necessary means to implement a highly secured system.

A dual-core microcontroller is the future trend. The processing efficiency achieved by parallel operation is much better than that by increasing clock speed alone. In addition, firmware real-time control can be achieved more easily. However, it results in increasing the complexity of circuit design for the microcontroller having dual-core architecture. Therefore, how to design the hardware layout of the internal elements of a microcontroller having dual-core architecture is needed to reduce hardware cost and to increase management efficiency. Moreover, when any processing core is shut down or has an error, how to let the system quickly back to normal operation is also an important task. In order to solve the above problems, the present invention is thus provided.

### SUMMARY OF THE INVENTION

In view of the above-mentioned problems, an object of the invention is to provide a microcontroller having dual-core architecture by common memory structure to save the hardware cost.

To achieve the above-mentioned object, the microcontroller having dual-core architecture according to the invention comprises: a processor bus; two processing cores each being electrically connected to the processor bus; one non-volatile memory electrically connected to the processor bus for storing firmware; and one volatile memory electrically connected to the processor bus for temporarily storing data.

Another object of the invention is to provide a microcontroller having dual-core architecture to utilize the allocation architecture of special global control registers and local control registers to increase the efficiency in managing the peripheral circuits. The microcontroller having dual-core architecture according to the invention comprises: a processor bus; two processing cores each being electrically connected to the processor bus; one global control register electrically connected to the processor bus for controlling the common peripheral circuits of the two processing cores; and two local control registers, each being built in each processing core for controlling the local peripheral circuits thereof.

Another object of the invention is to provide a microcontroller having dual-core architecture to utilize the allocation architecture of special global reset machines and local reset machines. When any processing core is shut down or has an error, the system can maintain local stability and quickly back to normal operation. The microcontroller having dual-core architecture according to the invention comprises: a processor bus; two processing cores each being electrically connected to the processor bus; a global reset machine electrically connected to the processor bus for generating a global reset signal to reset the microcontroller according to a first specific signal; and two local reset machines, each being built in each processing core, for resetting each core according to the global reset signal or a second specific signal.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a schematic diagram illustrating the architecture of the first embodiment of the invention.

FIG. 2 shows a schematic diagram illustrating the architecture of the second embodiment of the invention.

FIG. 3 shows a schematic diagram illustrating the architecture of the third embodiment of the invention.

FIG. 4 shows a schematic diagram illustrating the architecture of the fourth embodiment of the invention.

### DETAILED DESCRIPTION OF THE INVENTION

The microcontroller having dual-core architecture of the invention will be described with reference to the accompanying drawings.

It should be noted that, in the following embodiments, an 8-bit reduced instruction set computer (RISC) microcontroller having dual-core architecture is merely used as an example, and the architecture of the invention can be applied to other types of dual-core microcontrollers.

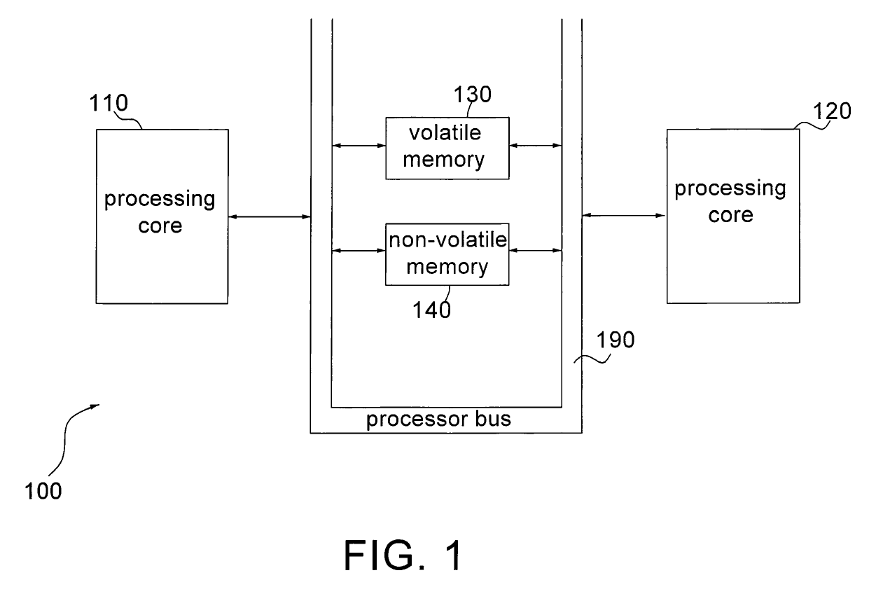

FIG. 1 shows a schematic diagram illustrating the architecture of the first embodiment of the invention. The dual-core microcontroller 100 according to the invention includes two processing cores 110 and 120, a volatile memory 130, a processor bus 190, and a non-volatile memory 140. The non-volatile memory 140 is used to store firmware or programs while the volatile memory 130 is used to temporarily store data. The processor bus 190 comprises at least one address bus, at least one data bus, and at least one control bus (not shown). The two processing cores 110 and 120 are electrically connected to the volatile memory 130 and the non-volatile memory 140 via the processor bus 190. It should be noted that the two processing cores 110 and 120 are not provided with any other memory inside except the volatile memory 130 and the non-volatile memory 140 in order to reduce hardware cost. In practice, it is adequate for a common microcontroller system to be provided with the shared volatile memory 130 and the shared non-volatile memory 140. The inside of the two processing cores 110 and 120 needs no additional memory.

In this embodiment, the processing cores 110 and 120 can access the volatile memory 130 via the processor bus 190, even for the same address of the volatile memory 130. On the other hand, when reading the program in the non-volatile memory 140, the processing cores 110 and 120 read the operating code (op-code) in the non-volatile memory 140 via the processor bus 190 separately in a different clock according to a time machine for execution. The limitation is that any op-code in the non-volatile memory 140 can only be executed by one of the two processing cores 110 and 120. In this embodiment, the volatile memory 130 can be implemented by a dynamic random access memory (DRAM), a static random access memory (SRAM), or a synchronous dynamic random access memory (SDRAM) while the non-volatile memory 140 can be implemented by a flash memory, an erasable programmable read-only memory (EPROM), or an electrically erasable programmable read-only memory (EEPROM).

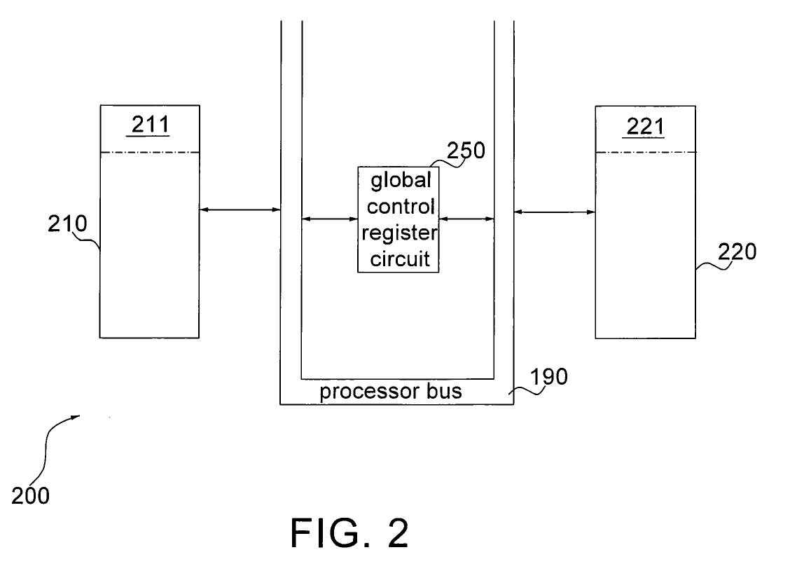

FIG. 2 shows a schematic diagram illustrating the architecture of the second embodiment of the invention. Referring to FIG. 2, the dual-core microcontroller 200 according to the invention includes two processing cores 210 and 220, a processor bus 190, and a global control register circuit 250. This embodiment comprises the global control register circuit 250 between the two processing cores 210 and 220 and two local control register circuits 211 and 221 provided inside the processing cores 210 and 220, respectively. The control register circuits 250, 221, 211 each comprise a plurality of registers.

The global control register circuit 250 can be accessed or controlled by the two processing cores 210 and 220 to control the common peripheral circuits, such as I/O port, timer, etc., of the microcontroller 200.

In other words, the processing cores 210 and 220 can control the common peripheral circuits via the global control register circuit 250. On the other hand, since the local control register circuits 211 and 221 are provided inside the processing cores 210 and 220, respectively, the two local control register circuits 211 and 221 are independent and can be accessed or controlled by the processing core, in which they are provided, that is, can not be accessed or controlled by the other processing core via the processor bus 190. For example, the local control register circuit 211 can only be accessed or controlled by the processing core 210 but can not be accessed or controlled by the processing core 220 via the processor bus 190. Thus, in the same manner, the local control register circuit 221 can only be accessed or controlled by the processing core 220. The local control register circuits 211 and 221 are used to control the local peripheral circuits therein, such as a timer inside the processing core, a watchdog timer, and an interrupt request, etc. The characteristic of this embodiment is to use the configuration relationship between the global control register circuit 250 and the two local control register circuits 211 and 221 to achieve better management efficiency on the local and global peripheral circuits.

The reset machine of a traditional microcontroller has a plurality of reset sources or initiative sources, such as power on reset, brown out reset, watchdog timer reset, and external reset, etc. As long as the reset machine of the traditional microcontroller is triggered, the reset signal generated by any reset source resets the whole system, thereby causing an unstable system.

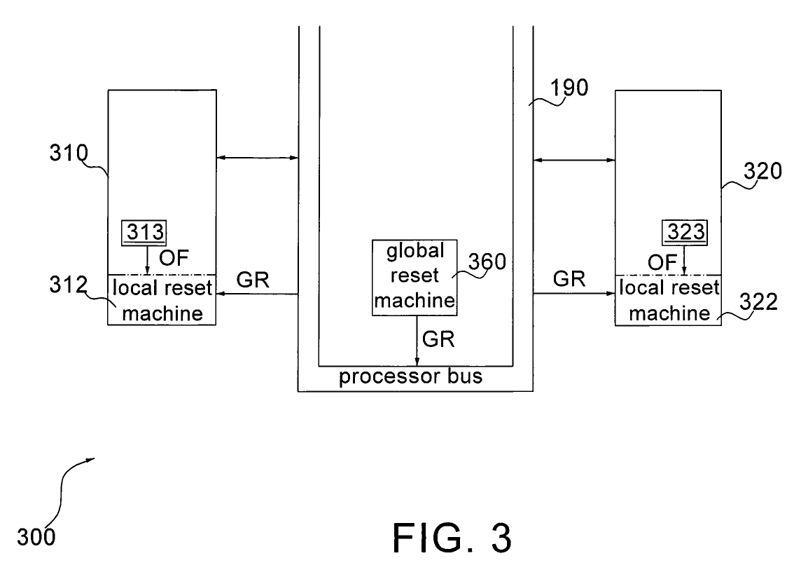

FIG. 3 shows a schematic diagram illustrating the architecture of the third embodiment of the invention. Referring to FIG. 3, the dual-core microcontroller 300 according to the invention includes two processing cores 310 and 320, a processor bus 190, and a global reset machine 360. In this embodiment, three reset machines are provided. One global reset machine 360 is allocated between the processing cores 310 and 320 and two local reset machines 312 and 322 are respectively allocated inside the processing cores 310 and 320.

According to the third embodiment, the reset sources of the global reset machine 360 comprise power on reset, brown out reset, and external reset by external circuits. The reset signal generated by any reset source can be a power on reset signal, a brown out reset signal, or an external reset signal (not shown). When receiving any of the three reset signals, the global reset machine 360 generates a global reset signal GR to trigger and reset the whole microcontroller system via the processor bus 190 to initialize the system. After receiving the global reset signal GR, the local reset machines 312 and 322 reset the processing cores 310 and 320, respectively.

On the other hand, the two local reset machines 312 and 322 are respectively allocated inside the processing cores 310 and 320. Thus, the two local reset machines 312 and 322 are independent and have no influence to each other. Except the global reset signal GR, the two local reset machines 312 and 322 can only be triggered by an overflow signal OF generated by the watchdog timers 313 and 323. The local reset machine 312 is now used as an example. As the overflow signal OF generated by the watchdog timer 313, only the processing core 310 is reset but the processing core 320 still operates normally. That is, the reset scope of the global reset machine 360 covers the whole microcontroller system while the reset scope of the local reset machines 312 and 322 is respectively limited to its own processing core. Thus, by the configuration of the global reset machine and the two local reset machines, the system can be more stable, more flexible, and have less possibility of breakdowns caused by local problems.

It should be noted that three different embodiments having different hardware allocation for memories, control registers, and reset machines are provided. The circuits can be designed by implementing the above embodiments or combination thereof to achieve double or triple effect and merits of the invention.

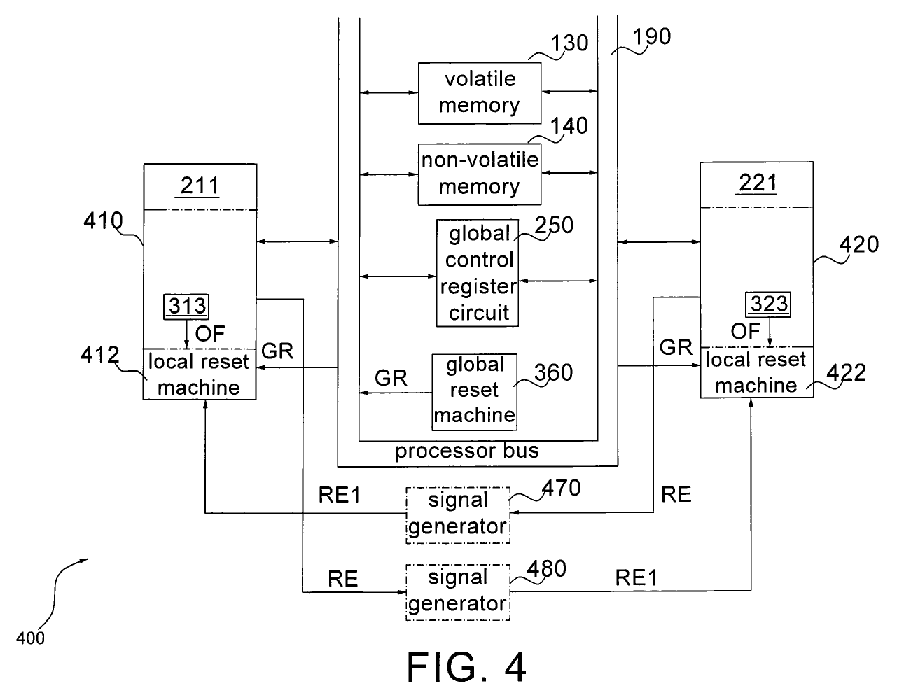

FIG. 4 shows a schematic diagram illustrating the architecture of the fourth embodiment of the invention. Referring to FIG. 4, the dual-core microcontroller 400 according to the invention includes two processing cores 410 and 420, a volatile memory 130, a non-volatile memory 140, a processor bus 190, a global control register circuit 250, two signal generators 470 and 480, and a global reset machine 360.

Except the basic arithmetic and logic unit (ALU) and the local timer, each processing core (410, 420) has one local reset machine (412, 422), one watchdog timer (313, 323), and one local control register circuit (211, 221) therein. In addition, one reset bit (not shown) is defined in each local control register circuit (211, 221). The characteristic of this embodiment gathers all of the merits in the first, second, and third embodiments. Besides, in this embodiment, the firmware stored in the non-volatile memory 140 further comprises a monitoring program to have the processing cores 410, 420 to monitor each other's operation via the common interface, such as the volatile memory 130 or the global control register circuit 250. The reset bit of one processing core will be set to a specific value if any error is generated in the other processing core. Following that, a local reset signal RE (or signal RE1) is generated to reset the other processing core, called “register reset”. For example, when there is an error or breakdown in the processing core 420, the monitoring program executed by the processing core 410 sets the reset bit of the local control register 211 to a specific value and then the processing core 410 issues a local reset signal RE according to the reset bit. The signal generator 480 generates a signal RE1 (for example, a pulse signal) with a specific waveform after receiving the local reset signal RE. The local reset machine 422 resets the processing core 420 once receiving the pulse signal RE1. It should be noted that the local reset machines 422 and 412 are designed to be triggered only by a pulse signal (or a signal with a specific waveform) and thus the signal generators 470 and 480 are needed to generate the pulse signal RE1. In another embodiment, the local reset machines 422 and 412 may be designed to be triggered only by a signal with a specific voltage level, that is, the local reset signal RE with the specific voltage level can trigger the local reset machine of the other processing core, and thus the signal generators 470 and 480 can be omitted. Since the existence of the signal generators 470 and 480 depends on the requirement of the circuits, the signal generators 470 and 480 are drawn by dotted lines in FIG. 4.

Similar to the third embodiment, the global reset machine 360 generates a global reset signal GR, when triggered by one of the reset sources, and then transmits to the whole system via the processor bus 190 to reset the whole system. When one of the two local reset machines (for example, the local reset machine 412) is reset, only the processing core 410 is reset and there is no effect on the operation of the processing core 420, the volatile memory 130, the non-volatile memory 140, the global control register circuit 250, and the peripheral circuits. Thus, the reset scope is limited. In this embodiment, the three signals that can trigger the local reset machine (412, 422) are an overflow signal OF, a pulse signal RE1 (or local reset signal RE), and a global reset signal GR. Since this embodiment further comprises a monitoring program and the above-mentioned register resetting method, this embodiment provides better real-time control and stability, compared to the third embodiment.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1 A microcontroller having dual-core architecture, comprising:
a processor bus;
two processing cores each being electrically connected to the processor bus;
a global control register circuit electrically connected to the processor bus for controlling a common peripheral circuit of the two processing cores; and
two local control register circuits, each embedded in each processing core for controlling its own local peripheral circuit.

2. The microcontroller according to claim 1, further comprising:
a global reset machine electrically connected to the processor bus, for generating a global reset signal to reset the microcontroller according to a first specific signal; and
two local reset machines, each embedded in each processing core, for resetting each processing core according to the global reset signal or a second specific signal.

3. The microcontroller according to claim 2, wherein the first specific signal is selected from the group consisting of a power-on reset signal, a brown out reset signal, an external reset signal and combinations thereof.

4. The microcontroller according to claim 2, wherein the second specific signal is an overflow signal generated by a watchdog timer.

5. The microcontroller according to claim 2, wherein each local control register circuit comprises a reset bit and, when the reset bit equals a preset value, its corresponding processing core where the reset bit is embedded generates a local reset signal.

6. The microcontroller according to claim 5, wherein the second specific signal is the local reset signal.

7. The microcontroller according to claim 5, further comprising:
two signal generators electrically connected between the two processing cores, each signal generator generating an output signal with a specific waveform after receiving the local reset signal, wherein the second specific signal is the output signal with the specific waveform.

8. The microcontroller according to claim 5, wherein the two processing cores monitors each other's operation, and, when an error generated by one processing core is detected, the reset bit of the other processing core is set to the preset value.

9. The microcontroller according to claim 1, which is an 8-bit reduced instruction set computer (RISC) microcontroller.

10. The microcontroller according to claim 1, further comprising:
a non-volatile memory electrically connected to the processor bus for storing firmware; and
a volatile memory electrically connected to the processor bus for temporarily storing data.

11. A microcontroller having dual-core architecture, comprising:
a processor bus;
two processing cores each being electrically connected to the processor bus;
a global reset machine electrically connected to the processor bus for generating a global reset signal to reset the microcontroller according to a first specific signal; and
two local reset machines, each embedded in each processing core, for resetting each processing core according to the global reset signal or a second specific signal.

12. The microcontroller according to claim 11, wherein the first specific signal is selected from the group consisting of a power-on reset signal, a brown out reset signal, an external reset signal and combinations thereof.

13. The microcontroller according to claim 11, wherein the second specific signal is an overflow signal generated by the watchdog timer.

14. The microcontroller according to claim 11, further comprising:
a non-volatile memory electrically connected to the processor bus for storing firmware; and
a volatile memory electrically connected to the processor bus for temporarily storing data.

15. The microcontroller according to claim 11, which an 8-bit reduced instruction set computer (RISC) microcontroller.

16. A microcontroller having dual-core architecture, comprising:
a processor bus;
two processing cores each being electrically connected to the processor bus;
a non-volatile memory electrically connected to the processor bus for storing firmware; and
a volatile memory electrically connected to the processor bus for temporarily storing data.

17. The microcontroller according to claim 16, further comprising:
a global reset machine electrically connected to the processor bus for generating a global reset signal to reset the microcontroller according to a first specific signal;
two local reset machines each embedded in each processing core for resetting each processing core according to the global reset signal or a second specific signal;
a global control register circuit electrically connected to the processor bus for controlling the common peripheral circuits of the two processing cores; and
two local control register circuits each embedded in each processing core for controlling the local peripheral circuits thereof.

18. The microcontroller according to claim 17, wherein each local control register circuit comprises a reset bit and, when the reset bit equals a preset value, its corresponding processing core where the reset bit is embedded generates a local reset signal.

19. The microcontroller according to claim 18, further comprising:
two signal generators electrically connected between the two processing cores, each signal generator generating an output signal with a specific waveform after receiving the local reset signal, wherein the second specific signal is the output signal with the specific waveform.

20. The microcontroller according to claim 18, wherein the two processing cores monitors each other's operation, and, when an error generated by one processing core is detected, the reset bit of the other processing core is set to the preset value.
